(19) United States
(12) Patent Application Publication
(10) Pub. No.: US 2026/0222071 A1
(43) Pub. Date: Jul. 30, 2026

(54) A QUADRUPLE GPON SMALL FORM-FACTOR PLUGGABLE DOUBLE-DENSITY OPTICAL MODULE

(71) Applicants: Altice Labs, S.A., Aveiro (PT); PICADVANCED, S.A., Ílhavo (PT)

(72) Inventors: Claudio GOMES FERREIRINHO LIMA RODRIGUES, Aveiro (PT); Alfonso Carlos ANTERO MIRANDA FIGUEIREDO, Aveiro (PT); Luis Miguel AMARAL HENRIQUES, Aveiro (PT); Francisco Manuel RUIVO RODRIGUES, Ilhavo (PT); António Luís DE JESUS TEIXEIRA, Ilhavo (PT)

(21) Appl. No.: 19/142,113

(22) PCT Filed: Dec. 19, 2023
(86) PCT No.: PCT/EP2023/025546

§ 371 Date: Jun. 20, 2025

(30) Foreign Application Priority Data
Dec. 21, 2022 (PT) 118429

(51) Int. Cl. H04B 10/40; H04B 10/27; H04B 10/50; H04J 14/02

(52) U.S. Cl. CPC H04B 10/40; H04B 10/27; H04B 10/505; H04J 14/0202

(57) ABSTRACT

The present invention relates to a Quadruple Gigabit Passive Optical Network Small Form-factor Pluggable Double-Density Module (QGPON-SFPDD), projected to provide four connections for GPON and to be incorporated in any state-of-the-art SFP-DD transceiver host to allow four GPON OLT technologies. The module comprises a case housing a specific set of technical elements such as a QPIC, a high-speed electrical interface, a control unit, a printed circuit board, and a flex interposer or connectivity circuit to ensure proper assembly and electronic performance of all elements.

### FIELD OF THE INVENTION

The present invention is enclosed in the area of Gigabit passive optical network (GPON) optical line terminals (OLT), particularly in the field of small form-factor pluggable modules double density (SFP-DD).

### PRIOR ART

Gigabit-capable Passive Optical Network (GPON) has been widely spread among operators allowing the distribution of high bandwidth, and large coverage, and providing high efficiency to deliver broadband. Based on International Telecommunication Union—Telecommunication Standardization Sector (ITU-T) G.984.x. GPON-OLTs commonly use small form-factor pluggable (SFP) transceiver hosts equipped with SFPs in a single fiber bidirectional SC connector configuration for carrying out the transmission and reception of the passive optical network (PON) data.

SFPs comprise a metallic case, a printed circuit board (PCB), a Bi-Directional Optical Sub-Assembly (BOSA), and flexible PCBs to connect the BOSA to the PCB. BOSA presently comprises a metal housing with a Transmitter Optical Sub-Assembly (TOSA) for optical transmitting, a Receiver Optical Sub-Assembly (ROSA) for optical receiving, an optical fiber or an optical connector to connect an optical fiber that connects to the external network, and a device used to route the light to and from the optical fiber.

### PROBLEM TO BE SOLVED

Current GPON SFP optical transceiver modules employ a single or double fiber bidirectional SC connector, limiting the port density on the GPON-OLT, where a single SFP transceiver host equipped with an SFP is adapted to feed a GPON, limiting the number of users connected to the said host and thereby limiting also its density.

The present invention addresses the above problem.

### SUMMARY OF THE INVENTION

The present invention relates to a Quadruple Gigabit Passive Optical Network Small Form-factor Pluggable Double-Density Module (QGPON-SFPDD), projected to provide a connection to four optical fiber connectors of four different PONs and to be incorporated in any state-of-the-art OLT supporting GPON.

Due to the set of technical features that characterizes the QGPON-SFPDD optical module developed, it is possible to quadruple the density of a transceiver, that is, for the same cage space, it allows four PON ports. The QGPON-SFPDD allows the transmitting and receiving of 4 PON channels in a single optical transceiver.

### DESCRIPTION OF FIGURES

FIG. 1 is a schematic diagram of the QGPON-SFPDD optical module developed based on a quad-photonic integrated circuit (QPIC), according to certain aspects of the invention. The numerical references represent:
10—QGPON-SFPDD optical module;
111—control unit;
112—high-speed electrical interface;
115—printed circuit board;
210—quad-photonic integrated circuit;
211—rigid or flex interposer or connectivity circuit (can be among others, wire bond, flip chip bumps or balls, interposer circuit board, flex-printed circuit board);
212—fiber;
213—SN adaptor cramp.

FIG. 2 is a schematic diagram of the QGPON-SFPDD module's control unit, according to certain aspects of the invention. The numerical references represent:
111—control unit;
112—high-speed electrical interface;
310—modulation sub-unit;
311—microcontroller;
312—power supply.

FIG. 3 is a diagram of the QGPON-SFPDD module contact assignment of the 40 pins high-speed electrical interface (HSEI) to the SFPDD transceiver host to support the quad GPON.

The module contact assignment is defined as:
Pin number 1—GPON1_TD+—Transmit Non-Inverted GPON1 Data Input;
Pin number 2—GPON1_TD−—Transmit Inverted GPON1 Data Input;
Pin number 3—GND—Module ground;
Pin number 4—SDA—2-Wire Serial Interface Data Line;
Pin number 5—SCL—2-Wire Serial Interface Clock;
Pin number 6—GPON1_RD−—Receive Burst Mode Inverted GPON1 Data output;
Pin number 7—Reset—Reset Receiver Burst Mode GPON2;
Pin number 8—GPON2_RXSD—Receiver Signal Detect indicator for GPON2 receiver;
Pin number 9—Trig_TxDisable—Two signals multiplex, which is selected by register: Receiver signal strength indication trigger and transmitter disable for GPON1 and GPON2;
Pin number 10—GPON1_RD+—Receive Burst Mode Non-Inverted GPON1 Data output;
Pin number 11—GND—module ground;
Pin number 12—GPON2_RD−—Receive Burst Mode Inverted GPON2 Data output;
Pin number 13—GPON2_RD+—Receive Burst Mode Non-Inverted GPON2 Data output;
Pin number 14—GPON1_RXSD—Receiver Signal Detect indicator for GPON1 receiver;
Pin number 15—VccR—power supply for the receiver;
Pin number 16—VccT—power supply for the transmitter;
Pin number 17—GPON1_Reset—Reset Receiver Burst Mode GPON1;
Pin number 18—GPON2_TD+—Transmit Non-Inverted GPON2 Data Input;
Pin number 19—GPON2_TD−—Transmit Inverted GPON2 Data Input;
Pin number 20—GND—Module ground;
Pin number 21—GPON3_TD+—Transmit Non-Inverted GPON3 Data Input;
Pin number 22—GPON3_TD−—Transmit Inverted GPON3 Data Input;
Pin number 23—GND—Module ground;
Pin number 24—NC—Not connected;
Pin number 25—NC—Not connected;
Pin number 26—GPON3_RD−—Receive Burst Mode Inverted GPON3 Data output;
Pin number 27—Reset—Reset Receiver Burst Mode GPON4;
Pin number 28—GPON4_RXSD—Receiver Signal Detect indicator for GPON4 receiver;
Pin number 29—Trig_TxDisable—Two signals multiplex, which is selected by register: Receiver signal strength indication trigger and transmitter disable for GPON3 and GPON4;
Pin number 30—GPON3_RD+—Receive Burst Mode Non-Inverted GPON3 Data output;
Pin number 31—GND—Module ground;
Pin number 32—GPON4_RD−—Receive Burst Mode Inverted GPON4 Data output;
Pin number 33—GPON4_RD+—Receive Burst Mode Non-Inverted GPON4 Data output;
Pin number 34—GPON3_RXSD—Receiver Signal Detect indicator for GPON3 receiver;
Pin number 35—VccR—power supply for the receiver;
Pin number 36—VccT—power supply for the transmitter;
Pin number 37—GND—Module ground;
Pin number 18—GPON4_TD+—Transmit Non-Inverted GPON4 Data Input;
Pin number 19—GPON4_TD−—Transmit Inverted GPON4 Data Input;
Pin number 40—GND—Module ground.

FIGS. 4, 5, 6, and 7 are options for the schematic diagram of a QPIC (210) package for use in the transceiver module shown in FIG. 2.

The numerical references represent:
400—holder;
410—WDM passive filter with the quadruple-double stage of add-drop filters;
411—optical coupling receptacle;
412—optical coupling receptacle;
413—optical coupling receptacle;
414—optical coupling receptacle;
415—fiber;
416—fiber;
417—fiber;
418—fiber;
419—V-groove;
420—V-groove;
421—V-groove;
422—V-groove;
423—GPON upstream add-drop filter;
424—GPON downstream add-drop filter;
425—GPON upstream add-drop filter;
426—GPON downstream add-drop filter;
427—GPON upstream add-drop filter;
428—GPON downstream add-drop filter;
429—GPON upstream add-drop filter;
430—GPON downstream add-drop filter;
431—lenses or photonic wire bonds;
434—lenses or photonic wire bonds;
437—lenses or photonic wire bonds;
440—lenses or photonic wire bonds;
443—lenses or photonic wire bonds;
446—lenses or photonic wire bonds;
449—lenses or photonic wire bonds;
452—lenses or photonic wire bonds;
433—interposer, wire bond, or simple deposited electrical waveguides and pads;
436—interposer, wire bond, or simple deposited electrical waveguides and pads;
439—interposer, wire bond, or simple deposited electrical waveguides and pads;
442—interposer, wire bond, or simple deposited electrical waveguides and pads;
445—interposer, wire bond, or simple deposited electrical waveguides and pads;
448—interposer, wire bond, or simple deposited electrical waveguides and pads;
451—interposer, wire bond, or simple deposited electrical waveguides and pads;
454—interposer, wire bond, or simple deposited electrical waveguides and pads;
432—PIN or APD;
438—PIN or APD;
444—PIN or APD;
450—PIN or APD;
435—light source;
441—light source;
447—light source;
453—light source;
455—built-in monolithically pin or apd;
456—built-in monolithically pin or apd;
457—built-in monolithically pin or apd;
458—built-in monolithically pin or apd;
459—built-in monolithically laser source;
460—built-in monolithically laser source;
461—built-in monolithically laser source;
462—built-in monolithically laser source.

FIG. 8 is a view of the case of the QGPON-SFPDD optical module developed with a double SN connector for integrating the QPIC, according to certain aspects of the invention. The numerical references represent:
510—MSA height of the rear part;
520—MSA width of the rear part;
530—MSA length of the transceiver, rear part;
540—front length;
550—front width;
560—front height;
570—total length of the transceiver.

FIG. 9 is an exploded view of the case and internal components of the QGPON-SFPDD optical module developed with a double SN connector, according to certain aspects of the invention. The numerical references represent:
115—printed circuit board;
112—high-speed electrical interface;
210—QPIC;
212—fiber;
213—SN adaptor cramp;
610—top case;
611—bottom case;
612—actuator tine;
613—pull-tab;
614—shield;

### DETAILED DESCRIPTION

The following detailed description has references to the figures. Parts that are common in different figures have been referred to using the same numbers. Also, the following detailed description does not limit the scope of the disclosure.

The present invention relates to a QGPON-SFPDD optical module comprising a double SN connector, projected to be connected in an SFP-DD transceiver host, allowing it to operate in GPON, four times transmitter, and receiver simultaneously.

According to the main embodiment of the invention, the QGPON-SFPDD optical module (10) is comprised of at least a QPIC (210), a control unit (111) comprising connection and processing means adapted to drive and control the QPIC (210) and a high-speed electrical interface-HSEI-(112) adapted to provide connection to the SFP-DD transceiver host Optical Network Units. These elements comprising the QGPON-SFPDD optical module (10) are housed in a case (113) which is to be installed inside the SFP-DD transceiver host cage of a GPON OLT.

FIG. 1 illustrates the block diagram of an exemplary embodiment of the QGPON-SFPDD optical module (10) of the invention. It is comprised of a case (113) housing one QPIC (110) for GPON connection, the control unit (111), and the high-speed electrical interface (112).

The QPIC (210) is composed of four lasers working on GPON downstream wavelength at 2.48 Gbit/s and four burst mode receivers working on GPON upstream wavelength at 1.24 Gbit/s. The QPIC (210) further includes four optical fibers coupled to an SN adaptor cramp (213) to allow the connection to a double SN optical fiber connector.

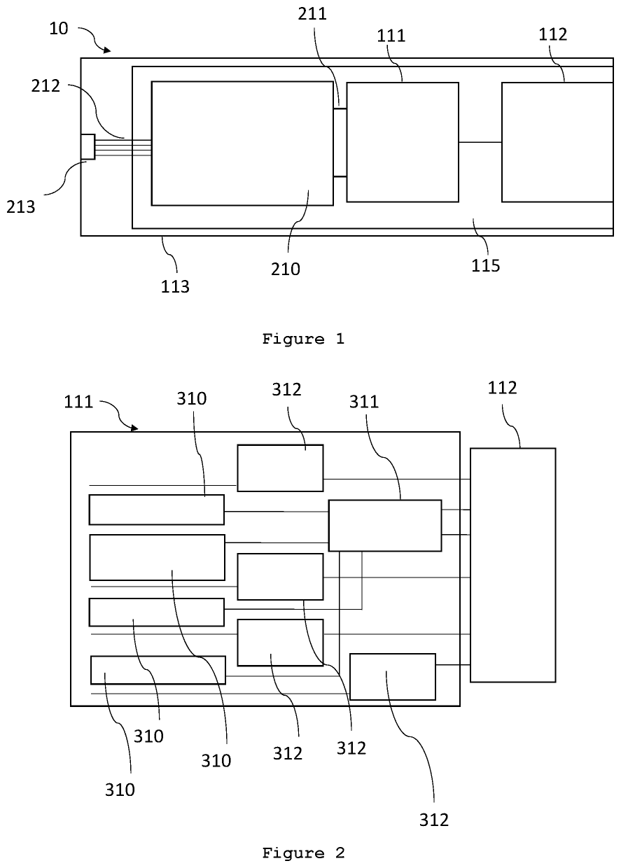

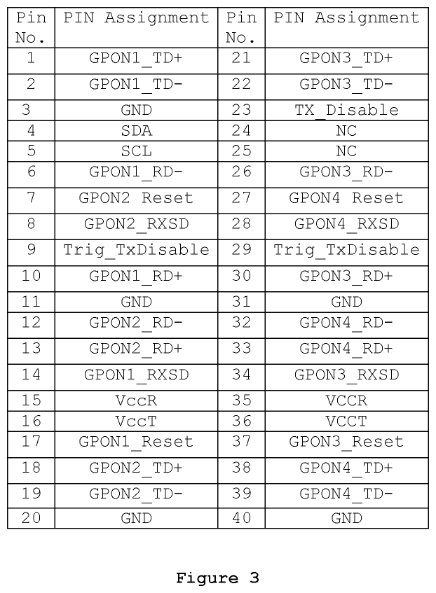

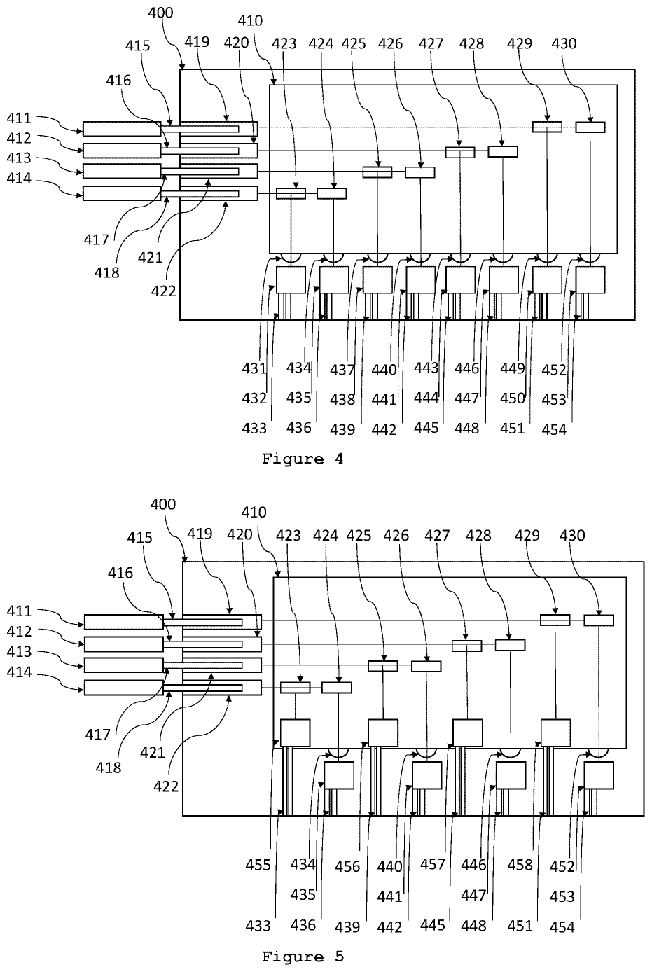

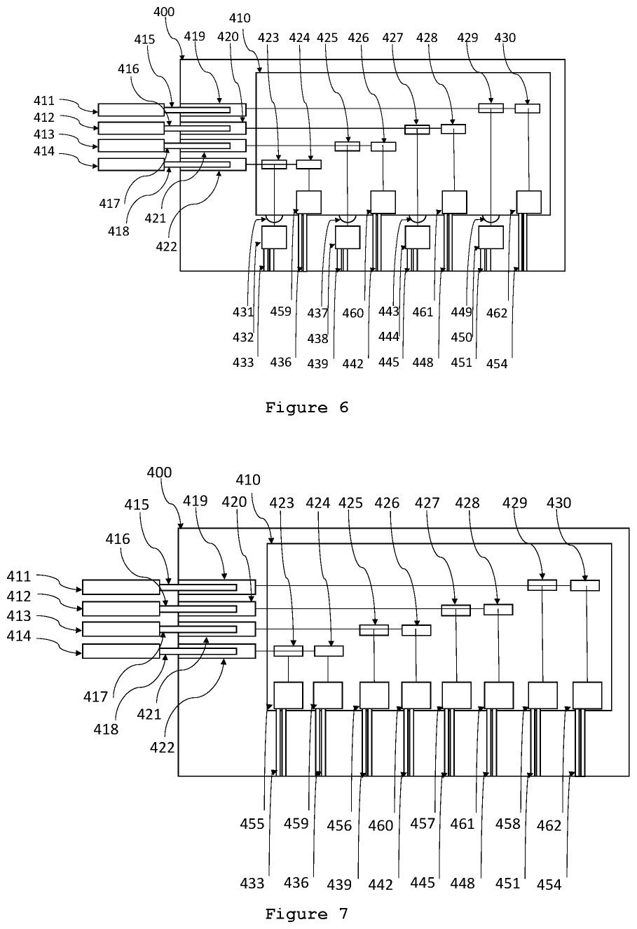

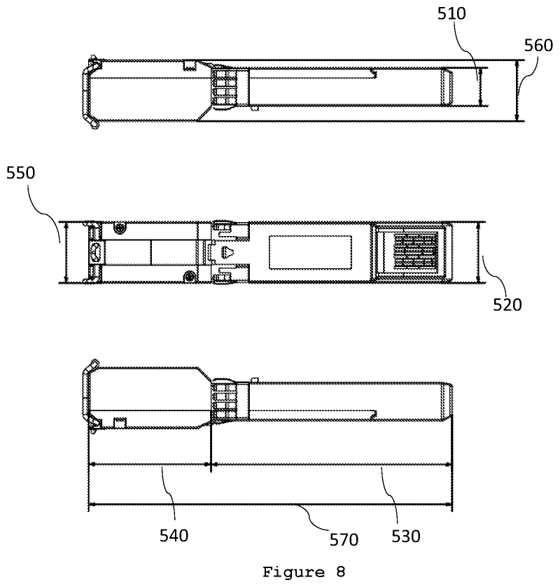

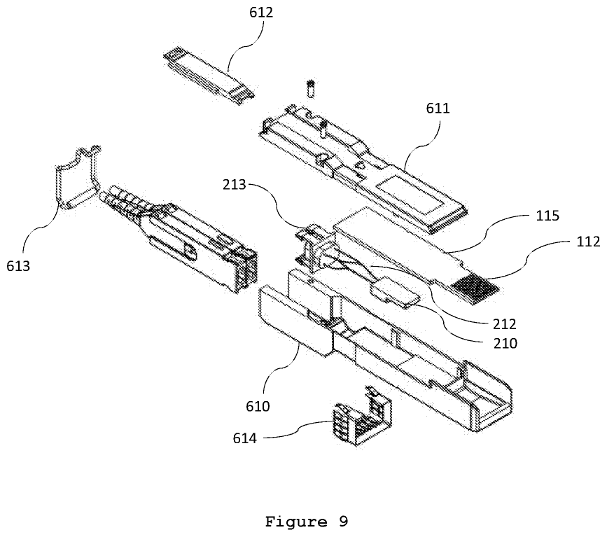

The control unit (111) is shown in FIG. 3 and is adapted to control the QPIC (210). For that purpose, the control unit (111) comprises four modulation sub-units (310) and a microcontroller (311), besides the required circuit electronics that comprise resistors, capacitors, power supply (312), and ferrite bead. The modulation sub-units (310) comprise laser drivers and limiting amplifiers adapted to drive and modulate the GPON lasers and amplify the electrical signals from the burst mode receivers of QPIC (210). The microcontroller (311) is configured to control the modulation sub-units (310) and to communicate with the SFP-DD host through the HSEI (112). The microcontroller (311) is also configured to control the QPIC (210) power supplies (312). The control unit (111) is mounted on a printed circuit board (115) containing all the necessary electrical connections between the different elements to control and drive the QPIC (210). The QPIC (210) package is mounted in the printed circuit board (115) containing all the necessary electrical connections between the different elements to control and drive the QPIC (210). More particularly, the QPIC (210) is connected to the modulation sub-units (310) of the control unit (111), and in particular to the respective laser driver and limiting amplifier through the printed circuit board (115) to guarantee the electronic performance. The modulation sub-units (310) comprise laser drivers and limiting amplifiers adapted to convert NRZ signals from HSEI (112) to drive and modulate the lasers and amplify the electrical signals from the burst mode receivers of QPIC (210).

The forty-pin HSEI (112) is configured to provide a high-speed interconnection to the SFP-DD transceiver host, to transmit electrical signals that were transformed by the QGPON-SFPDD optical module (10) from the different PON data received. Similarly, the QGPON-SFPDD optical module (10) may receive electrical signals from the SFP-DD transceiver host via said port connector, to be transformed to optical signals and sent to a fiber network via optical connection.

For the connection with the SFP-DD transceiver host, the HSEI (112) comprises a port connector including a plurality of connection pins. In a particular embodiment, the port connector of the forty pins HSEI (112) is provided with a specific contact assignment, to ensure adaptability and compatibility with the state-of-the-art SFP-DD transceiver hosts. FIG. 4 depicts a port connector and respective receptacle which is comprised of forty pins. In the embodiment illustrated in FIG. 4, pin 9 is used to both disable the GPON1 and GPON2 laser transmission and to measure the optical input power on the receiver of the GPON1 and GPON2 QPIC (210), representing the received signal strength indication-RSSI. This pin function is selected on a memory pin map of the SFP-DD module, through the SDA (data line) and SCL (clock line) pins, stored on the memory of the microcontroller (220), to act as transmitter disable of the GPON1 and GPON2 of the QPIC (210), or as RSSI of the GPON1 and GPON2 of the QPIC (210). In the embodiment illustrated in FIG. 4, pin 29 is used to disable the GPON3 and GPON4 laser transmission and to measure the optical input power on the receiver of the GPON3 and GPON4 of the QPIC (210), representing RSSI. This pin function is selected on a memory pin map of the SFP-DD module, through the SDA (data line) and SCL (clock line) pins, stored on the memory of the microcontroller (220), to act as transmitter disable of the GPON3 and GPON4 of the QPIC (210), or as RSSI of the GPON3 and GPON4 of the QPIC (210).

FIGS. 4, 5, 6, and 7 are options for the schematic diagram of a QPIC (210) package for use in the transceiver module shown in FIG. 1. The QPIC (210) package comprises a holder (400) which has a V-groove (419, 420, 421 and 422) for connecting four fibers (415, 416, 417 and 418) which hold optical coupling receptacles (411, 412, 413 and 414). This holder (400) has also the function of allowing hybrid assembling of the different devices, keeping them together and aligned for the different options, FIGS. 4, 5, 6, and 7. In FIG. 4, (410) is a WDM passive filter with a quadruple-double stage of add-drop filters (423 to 430) each shaped to meet the GPON upstream (423, 425, 427, and 429) and GPON downstream (424, 426, 428 and 430) which characteristics can be obtained from each of the standards. In FIG. 5, (410) is a WDM passive filter exactly matching the configuration of the WDM filter of FIG. 4, however in this configuration (423, 425, 427, and 429) are connected through a waveguide to an integrated PIN or APD (455, 456, 457 and 458) respectively. In FIG. 6, (410) is a WDM passive filter exactly matching the configuration of the WDM filter of FIG. 4, however in this configuration (424, 426, 428 and 430) are connected through a waveguide to laser sources built monolithically inside (459, 460, 461 and 462) respectively. In FIG. 7 (400) holds monolithically the receivers (455, 456, 457, and 458), the transmitters (459, 460, 461, and 462), and their connections to the exiting WDM filters (423 to 430) similar to FIG. 4. (431, 434, 437, 440, 443, 446, 449, and 452) are lenses or photonic wire bonds which, in the options, connect to each of the discrete devices, serving as an interface for the photonic path. (432, 438, 444, and 450) are external receivers, which can be instantiated as PINs or APDs, which are connected electrically through an interposer, wire bond, or simple deposited electrical waveguides and pads, (433, 439, 445 and 451). (436, 442, 448, 454, 459, 460, 461, and 462) are optical sources that can be intrinsically directly modulated lasers (DML), externally modulated lasers (EML), considering each of the specific configurations, which are driven through the electrical connections (interposer, wire bond, or simple deposited electrical waveguides and pads) to the external drivers.

FIG. 8 illustrates the mechanical case (113) design of the QGPON-SFPDD optical module (10) developed. It assumes a standard SFP-DD Transceiver Multisource Agreement (MSA) size inside a cage assembly: MSA height of the rear part (510), MSA width of the rear part (520), and MSA length of transceiver outside of the cage to rear (530) to fit on a standard SFP-DD Cage Assembly of the SFP-DD transceiver host. The QGPON-SFPDD optical module (10) dimensions outside of the cage MSA, to fit the double SN connector, assume a specific front length (540) of 27,50 mm, front width (550) of 13,70 mm, and a front height (560) of 13.70 mm. The total length of the transceiver (570) is 81,65 mm.

The QGPON-SFPDD optical module comprises a case (113) which includes a double SN connector adaptor cramp (213) adapted to accommodate the fiber connection (212) to the QPIC (210). Additionally, and as shown in FIG. 9, the case (113) may also comprise other mechanical parts such as a bottom case (611), a top case (610), and one actuator tine (612) to allow the extraction of the QGPON-SFPDD optical module (10) from the SFP-DD transceiver host case, and a pull-tab (613) to allow to manually pull the QGPON-SFPDD optical module (10).

The QGPON-SFPDD optical module mechanical parts, (610), (611), (612), (613), and (614) are made from several types of metallic materials such as zinc alloys, zamak 2 zamak 3, or aluminum. The double SN connector adaptor cramp (213) is manufactured in plastic or metal.

The physical geometry of the QGPON-SFPDD optical module (10) developed is to be such that it may fit within the receptacle case of a conventional GPON SFP-DD OLT transceiver.

The QGPON-SFPDD optical module (10) developed may be one of the multiple SFPDD-MPM optical modules (10) incorporated into the SFP-DD transceiver hosts of a GPON OLT. In certain embodiments, inserting a QGPON-SFPDD optical module (10) into an SFP-DD transceiver host configured to operate just in one GPON port may result in the QGPON-SFPDD optical module (10) being only able to establish a single optical connection.

As will be clear to one skilled in the art, the present invention should not be limited to the embodiments described herein, and several changes are possible that remain within the scope of the present invention.

Of course, the preferred embodiments shown above are combinable, in the different possible forms, being herein avoided the repetition of all such combinations.

1. A Quadruple Gigabit Passive Optical Network Small Form-factor Pluggable Double-Density Module (QGPON-SFPDD) projected to be incorporated in a small formfactor double density (SFP-DD) transceiver host of a GPON-OLT;
an optical module being characterized by comprising:
a case housing:
at least a QPIC subassembly
a control unit comprising connection and processing means adapted to drive and control a Hexa-BOSA subassembly or the QPIC subassembly; and
a high-speed electrical interface-HSEI adapted to provide connection to an SFP-DD transceiver host of a GPONOLT.

2. The module according to claim 1, wherein the QPIC subassembly comprises:
a holder which has four V-groove for connecting four fibers that hold optical coupling receptacles the holder is configured to allow hybrid assembling of different devices keeping them together and aligned;
a WDM passive filter designed in a photonic integrated circuit to meet requirements of GPON;
a waveguide to integrated PIN or APD;
laser sources built-in monolithically
receivers built-in monolithically
lenses or photonic wire bonds which connect to each of discrete devices, serving as an interface for the photonic integrated circuit;
optical sources which can be intrinsically directly modulated lasers or externally modulated lasers;
electrical connections and;
interposer, wire bond, or simple deposited electrical waveguides and pads.

3. The module according to claim 1, wherein the QPIC subassembly further comprise a double SN adaptor cramp adapted to provide connection to a double SN optical fiber connector.

4. The module according to claim 1, wherein the control unit comprises:
a modulation sub-unit comprising four laser drivers and four limiting amplifiers elements, adapted to drive and modulate the lasers and to amplify electrical signals from a burst mode receiver of the QPIC; and a microcontroller configured to communicate with the SFP-DD transceiver host through the HSEI and to control an operation of the modulation sub-unit.

5. The module according to claim 4, wherein the connection between the QPIC and the respective laser driver and limiting amplifier of each modulation subunit is provided through a rigid or flex interposer or connectivity circuit (can be among others, wire bond, flip chip bumps or balls, interposer circuit board, flex-printed circuit board).

6. The module according to claim 1, wherein the HSEI is a forty-pin high-speed electrical interface, is configured to provide connection to the SFP-DD transceiver host where the QGPON-SFPDD is incorporated employing a port connector.

7. The module according to claim 6, wherein the port connector is comprised of a plurality of pins, and wherein a microcontroller further comprises memory means adapted to store a memory pin map of the port connector;
the microcontroller being further programmed to select a pin function of each pin of the port connector based on the memory pin map; and
optionally, the port connector is comprised of forty pins.

8. The module according to claim 1, wherein the case comprises at least one double SN adaptor cramp to accommodate a fiber connection to an installation of at least one or QPIC.

9. The module according to claim 8, wherein the SN adaptor cramp is made from a plastic material.

10. The module according to claim 8, wherein the case further comprises:
a bottom and a top part;
one actuator tine adapted to allow an extraction of the module from a SFP-DD transceiver host's cage where it is incorporated;
a pull-tab to allow a manual pull of the module.

11. The module according to claim 8 wherein a bottom and top parts, an actuator tine and a pull-tab are made from metal; optionally the metal is zinc alloys, zamak 2, zamak 3, or aluminum.

12. The module according to claim 1, wherein a size of the case is standardized to fit within a receptacle cage of an SFP-DD transceiver host.

13. An SFP-DD transceiver host comprising at least one QGPON-SFPDD optical module according to claim 1.

14. A GPON-OLT comprising at least one QGPON-SFPDD QGPON-SFPDD transceiver host according to claim 13.
